(19) United States
(12) Patent Application Publication
(10) Pub. No.: US 2003/0167250 A1
(43) Pub. Date: Sep. 4, 2003

(54) Information delivery system

(76) Inventor: Yaakov Sash, Brooklyn, NY (US)

Correspondence Address: Joseph E. Levi, Zimmerman & Levi, 226 St. Paul St., Westfield, NJ, 07090, US

(21) Appl. No.: 09/864,599

(22) Filed: May 24, 2001

(51) Int. Cl. G06F 7/00

(52) U.S. Cl. 707/1

(57) ABSTRACT

A system is provided for delivering information from a plurality of content providers to a plurality of recipients and includes a plurality of information templates where each of the plurality of information templates includes information provided from one of the plurality of content providers. A priority manager is included for managing priority information of each of the plurality of recipients. Also included is a template database for storing the plurality of information templates. The system presents at least one of the plurality of recipients with at least one of the information templates according to the priority information of the at least one of the plurality of recipients.

### BACKGROUND OF THE INVENTION

The following invention relates to a system and method for delivering information and, in particular, to a system and method for managing the delivering of information from a plurality of information providers to a plurality of recipients.

The Internet has emerged as a worldwide communications medium that has become the backbone of global information exchange and electronic commerce. The Internet provides a number of mechanisms with which information providers can broadly disseminate information. One such mechanism is electronic mail that is comprised of electronic mail servers distributed throughout the Internet that direct an electronic mail message from a sender to a recipient. An information provider may send information to a list of recipients by “broadcasting” the electronic message containing the information to all the recipients on the list. Also, recipients desiring to receive information from a particular information provider are often able to “subscribe” with the information provider to receive the desired information. Thus, electronic mail is a mechanism that enables the transfer of information from content providers to recipients.

While electronic mail is ubiquitous and popular, it has several limitations especially as a tool for content providers to deliver large amounts of information to many recipients. First, the content providers must acquire and manage a list of valid email addresses of recipients that desire to receive the information provided by the content provider. Assuming the content provider can construct a qualified list of recipients, the content provider must also maintain a costly email system for managing the process sending information to the recipients. Furthermore, each content provider that uses electronic mail to deliver information to recipients incurs these message delivery costs.

Another shortcoming of email is that recipients are often bombarded with unsolicited email (also known as spam). Recipients are at the mercy of spammers, because there is no way for recipients to request that spammers do not send them email. Although companies have introduced spam filters to filter out spam email from legitimate email, the spam filter may filter legitimate email as well, which means that recipients still have to manually review all their email. The fear of receiving spam causes recipients to withhold their email address from legitimate content providers to insure that their email address does not leak out and fall into spammers' hands.

Another limitation of email is that recipients who subscribe to many legitimate content providers are bombarded with numerous messages on a constant basis making it difficult for recipients to read and organize all the information they receive.

The most serious limitation with email from the content provider's perspective is that once a content provider publishes information via email, there is no way for the content provider to take back the email or stop the email from being disseminated further. An example of this is a press release with incorrect information that is financially damaging. If the press release was published accidentally under current email systems, there would be no way for the content provider to stop the financially damaging information from being distributed further.

Another mechanism by which information providers can broadly disseminate information is through the use of the World Wide Web (“WWW”), which is a system that operates on the Internet and that organizes information into web pages that are viewed by computer running web browser software. Thus, a content provider may publish information on a web page and have it viewed, potentially, by any browser-enable device connected to the Internet. By publishing information on a web page, the content provider does not have to specifically identify a list of recipients and manage the delivery of information to those recipients, as in the case of electronic mail. Publishing information on web page can therefore be a cost effective way of broadly dissemination such information.

Publishing information on a web page, however, also has drawbacks as a tool for efficiently distributing information to a group of recipients. First, because there are millions of web pages on the WWW, the content provider posting a web page on the WWW has to devise strategies to attract web surfers to view their web pages. These strategies include placing hyperlinks on high-traffic web sites often at considerable expense. Also, because the typical web surfer may have hundreds of favorite web pages “bookmarked” for further viewing, it is very difficult for the web surfer to absorb the information contained on the web pages and monitor any changes to the information contained therein. Thus, an information provider merely posting information on a web page is not guaranteed that the intended recipients have viewed the information.

Another technique for delivering information to a broad group of recipients is through content aggregation web sites such as, for example, My Yahoo (http://my.yahoo.com). Content aggregation sites, also known as personal portals, gather various types of information, such as news, stock information and sports scores, as well as productivity tools such as email and calendaring, and places them on a web page uniquely accessible by a subscriber to the personal portal service. In addition, the personal portal may allow the subscriber to customize its web page by adding additional information sources and tools, as well as by modifying the portal layout.

Although the prior art personal portals do aggregate information, the personal portals only offer the subscriber a selection of information that is limited to the content providers supported by the personal portal and selected by the subscriber. The subscriber, however, cannot receive information from a content provider not supported by the personal portal site and not selected by the subscriber. Because personal portal sites, like My Yahoo, have typically developed business relationships with a small subset of content providers on the Internet, the subscriber is generally limited to the information provided by that small group of content providers. Furthermore, the prior art personal portals do not provide a mechanism by which information from a group of content providers is prioritized based on the priority of the information according to the subscriber's preferences. Thus, personal portals are not effective in delivering to subscribers a broad range of information according to a subscriber's personal preferences.

Accordingly, it is desirable to provide an efficient way for distributing to plurality of recipients a broad range of information gathered from a plurality of content providers based on the relevancy and timeliness of the information and according to the preferences of each particular recipient.

### SUMMARY OF THE INVENTION

The present invention is directed to overcoming the drawbacks of the prior art. Under the present invention a system and method is provided for delivering information from a plurality of content providers to a plurality of recipients and includes a plurality of information templates where each of the plurality of information templates includes information provided from one of the plurality of content providers. A priority manager is included for managing priority information of each of the plurality of recipients. Also included is a template database for storing the plurality of information templates. The system presents at least one of the plurality of recipients with at least one of the information templates according to the priority information of the at least one of the plurality of recipients.

In an exemplary embodiment, at least one information template sender is included and the at least one information template sender causes at least one of the plurality of information templates from one of the plurality of content providers to be presented to at least one of the plurality of recipients according to deliver criteria. The delivery criteria includes a priority measure and a response priority measure of the at least one of the plurality of information templates.

In yet another exemplary embodiment, the priority information includes general priority information, sent priority information and sender priority information provided by said at least one of said plurality of recipients. The priority manager forms a sequence of information templates from some of the plurality of information templates based on the subscriber priority information, the delivery criteria, the general priority information, the sent priority information and the sender priority information. The sequence of information templates is then presented to at least one of said recipients.

Accordingly, a system and method is provided for distributing to a plurality of recipients a broad range of information gathered from a plurality of content providers based on the preferences of each particular recipient and the relevancy and timeliness of the information.

The invention accordingly comprises the features of construction, combination of elements and arrangement of parts that will be exemplified in the following detailed disclosure, and the scope of the invention will be indicated in the claims. Other features and advantages of the invention will be apparent from the description, the drawings and the claims.

### DESCRIPTION OF THE DRAWINGS

FIG. 1 is a block diagram of a system for delivering information according to the present invention.

FIGS. 2 and 3 are screenshots illustrating the process by which a subscriber to the system of FIG. 1 subscribes to receive information.

FIGS. 4 and 5 are shown screenshots illustrating the process by which a information template sender sends information to subscribers of the system of FIG. 1.

FIG. 6 is a screenshot showing the format in which information is presented to a subscriber by the system of FIG. 1.

FIG. 7 is an input screen into which subscribers enter general priority information.

FIG. 8 is an input screen into which subscribers enter sent message priority information.

FIG. 9 is an input screen into which subscribers enter sender priority information.

### DETAILED DESCRIPTION OF THE PREFERRED EMBODIMENTS

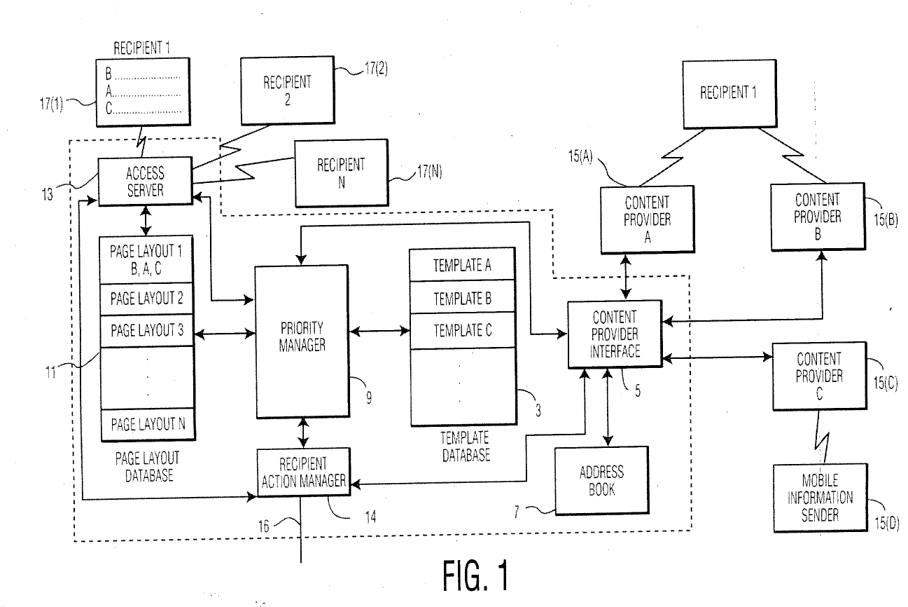

Referring now to FIG. 1, there is shown a system 1 for delivering information according to the present invention. Central to the operation of system 1 is an information template. An information template may be any information provided by a content provider intended for a recipient to view. The information contained in an information template may be, by way of non-limiting example, a news article, sales promotions or multimedia-based entertainment. Generally, an information template is a portion of a content file that a content provider uses to attract the recipient. If, after viewing the information template, the recipient would like to view the entire content file, the recipient activates a hyperlink provided in the information template which directs the recipient to the desired content file.

In a preferred embodiment, system 1 is hosted on a server computer that is in communications with the Internet using well-known techniques. A plurality of recipients 17 and a plurality of content providers 15 operating, for example, personal computers, access system 1 using techniques well known in the art.

System 1 receives a plurality of information templates from content providers 15. The information templates are received by system 1 as a result of recipients 17 subscribing to content providers 15 for such information templates. In addition, system 1 may receive information templates from some of content providers 15 at the direction of an information template sender 19 that has accessed those of content providers 15 by (a) sending it from the website of content provider 15, or (b) forwarding information templates received via a content provider 15 subscription. Aside from receiving information templates from content providers 15, system 1 also receives preference and priority information that has been designated by recipients 17 and delivery criteria that has been designated by information template sender 19. For each of recipients 17 of system 1, system 1 arranges the information templates in an order that is consistent with the preferences and priorities designated by that particular one of recipients 17 and any relevant delivery criteria associated with any particular information template. Each of recipients 17 may then access system 1 and view the information templates that they received from content provider's 15 subscriptions according to the priority associated with such subscription. In addition, each of recipients 17 may view information templates sent at the direction of information template senders 19 according to the delivery criteria associated with such templates.

Referring now to FIG. 2, there is shown a screenshot of a web page 21 associated with a web site from which recipient 17 may subscribe to receive a particular type of information. This is called a “subscription.” Content provider 15 is not limited to what a content provider 15 is allowed to publish to recipients 17. If content provider 15 ever starts to violate the spirit of the original subscription, recipient 17 can just unsubscribe. The fear of subscribers unsubscribing is what keeps content providers honest.

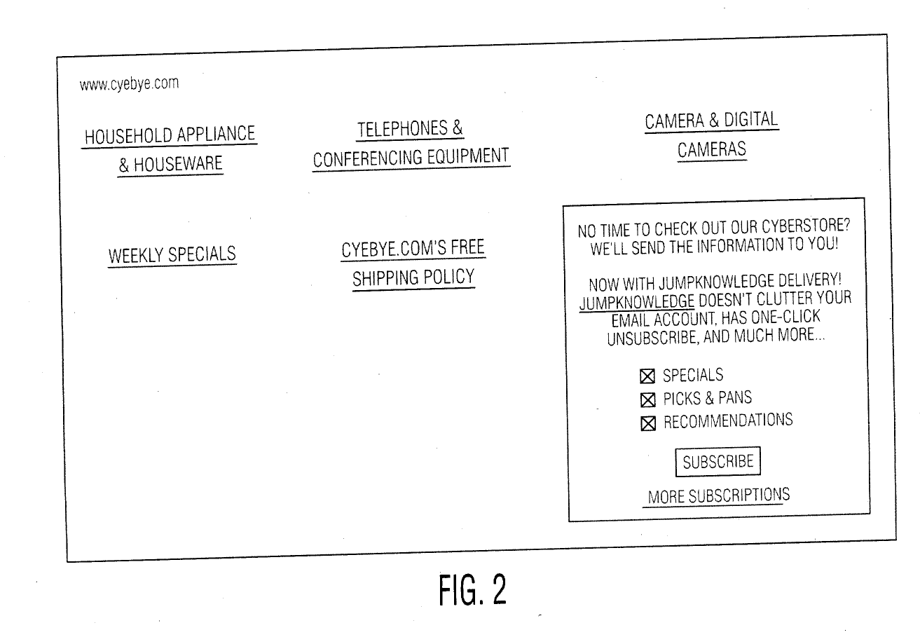

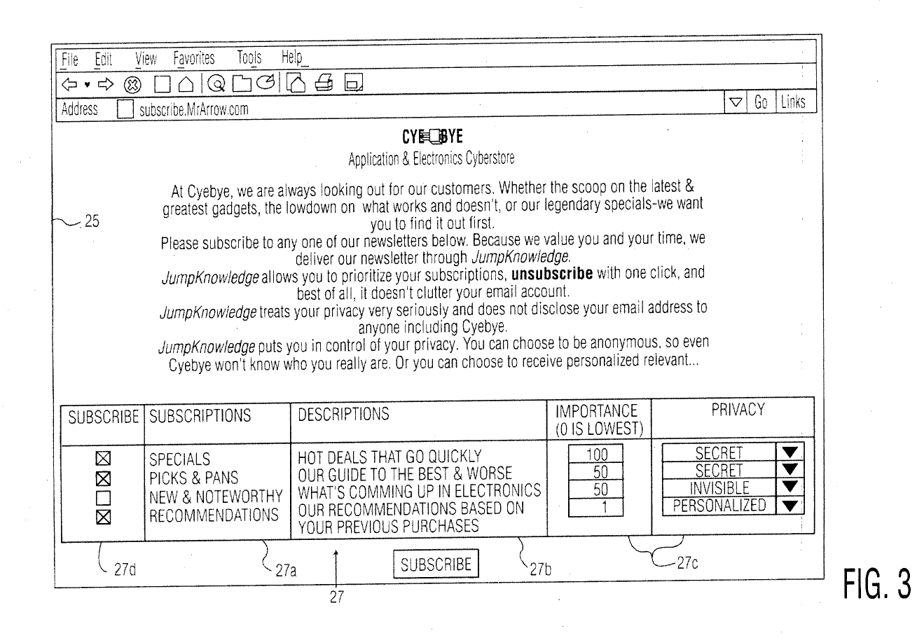

As an example, web page 21 is part of an e-commerce site that sells appliances and electronics. Recipient 17 may want to subscribe to the e-commerce site to receive information templates regarding specials deals, recommendations and other information. If recipient 17 decides to subscribe to such information templates, recipient 17 activates a hyperlink 23 using, for example, a computer mouse according to techniques well known in the art, which directs recipient 17 to a subscription page 25 that is shown in FIG. 3. It will be obvious to one of ordinary skill to have subscription page 25 hosted on any Internet-connected server including, but not limited to, the server that hosts content provider page 21 or the server that hosts system 1. In either case, the look and feel of subscription page 25 may be designed to look similar to web page 21 or other pages associated with the particular web site.

Subscription page 25 includes a subscription box 27 that includes the various types of information templates and subscription options available from the e-commerce site. In the embodiment shown in FIG. 3, subscription box 27 includes a template type section 27a that provides recipient 17 with four types of information templates from which to select—“Specials,” “Picks & Pans,” “New and Noteworthy.” and “Recommendations.” A description section 27b is also included in subscription box 27 and provides a description for each template type included in template type section 27a. For example, the “Specials” template type may include any number of information templates relating to hot deals that go quickly. Also included is a selection section 27d that contains a checkbox corresponding to each information template type. To subscribe to an information template type, recipient 17 selects any or all check boxes contained in selection section 27d.

Subscription box 27 also include subscription preferences 27c in which recipient 17 is required to specify a priority and privacy preference for each desired subscription. The priority preference allows recipient 17 to specify a level of interest. The privacy preference allows recipient 17 to specify how much privacy and anonymity to give up in exchange for more personalized and relevant information from content provider 15.

In an exemplary embodiment, recipient 17 may be required to specify as part of the privacy preference which information from recipient's 17 personal profile has to be entered and made accessible to content provider 15. Personal profile information may contain address information, telephone numbers, date of birth, gender, sex, income, marital status, siblings' gender and ages, children's gender and ages, education level completed, written and spoken language preference, work industry, company name, work title, interests, hobbies, and other demographic-type information.

In another exemplary embodiment, content provider 15 has the ability to define custom subscription preferences which can be anything that content provider 15 considers necessary to deliver more personalized and relevant information to recipient 17. In yet another exemplary embodiment, content provider 15 can define what subscription preferences (including custom subscription preferences) recipient 17 is required to enter in order to subscribe.

Based on the priority preference, system 1 will organize the information templates subscribed to by recipient 17. In the example of FIG. 3, because recipient 17 has indicated that information templates pertaining to “Specials” is of a high priority while information templates pertaining to “Recommendations” is of a low priority, system 1, upon receiving information templates of those template types on behalf of recipient 17, will present to recipient 17 information templates of the “Specials” subscription ahead of information templates of the “Recommendations” subscription. The subscription priority preference provided by recipient 17 is also used by system 1 to prioritize information templates that originate from different content providers 15. Thus, if recipient 17 subscribes to various information templates from content providers 15a and 15b, the subscription priority preference provided by recipient 17 for each information template type are used by system 1 to organize all the information templates received from content providers 15a and 15b according the priority indicated by recipient 17.

Recipient 17 can choose from three privacy preferences, which are: Secret, Invisible, or Personalized. If recipient 17 chose the Secret privacy preference, then content providers 15 is only allowed to publish an information template to recipients 17 in a bulk anonymous manner, and is not permitted to publish specific information templates to specific recipients 17 (either by specifying a particular recipient 17 or by specifying a group of recipients 17 that fulfilled certain past actions or inactions.) However, content providers 15 are allowed to publish information templates to a subset of recipients 17, which System 1 chooses in a random manner to preserve their privacy and anonymity.

If recipient 17 chose the Invisible privacy preference, then content providers 15 is permitted to publish information templates to recipients 17 based on publishing criteria. The publishing criteria are compared against each recipient's 17 subscription preferences 27c and personal profile. But only the personal profile information that recipient 17 designated accessible as part of their privacy preference is permitted to be compared against. The information template is then published to all recipients 17 that match content provider's 15 publishing criteria. To preserve the recipient's 17 privacy and anonymity, content providers 15 can only publish information templates if the population of recipients 17 that match content provider's 15 publishing criteria is greater than a specified number, for example, 100.

If recipient 17 chose the Personalized privacy preference, then content provider 15 is allowed to publish information templates to specific recipients 17 on a one-on-one basis. For example, an ecommerce book merchant may want to send a “recommendation” information template to a specific recipient 17 based on recipient 17's book purchase history. System 1 will only allow the ecommerce book merchant to publish the information template to the recipient 17 if recipient 17 chose the Personalized privacy preference.

In an exemplary embodiment, a content provider screen (not shown) is used by content provider 15 to define the information template and to publish the information template to particular recipients 17.

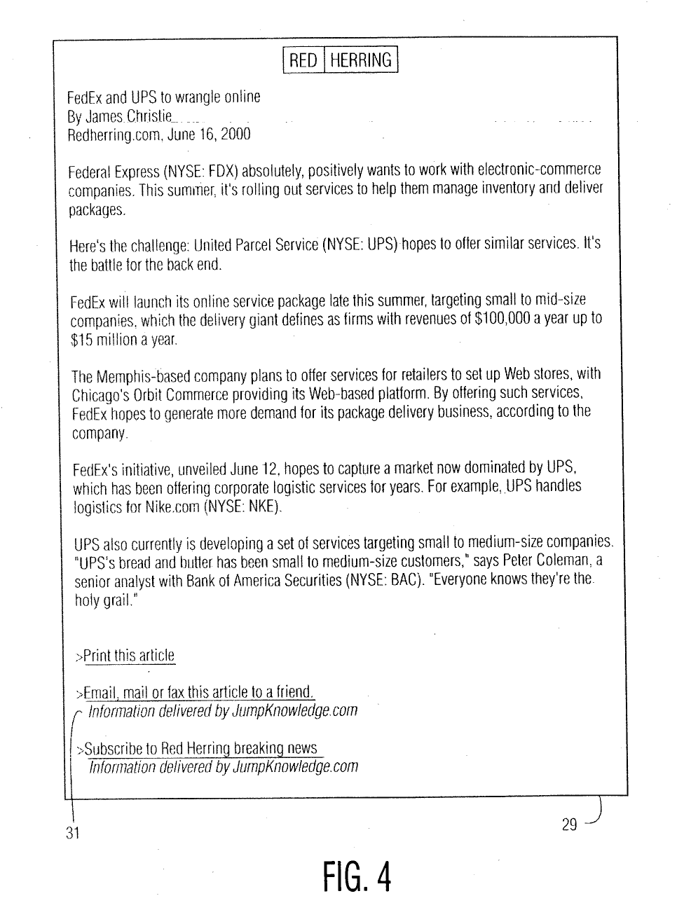

Referring now to FIGS. 4 and 5, there are shown screenshots depicting the process by which information template sender 19 may send information templates to recipients 17. For example, information template sender 19 finds an article 29 on a certain web site that information template sender 19 believes would be of interest to recipient 17. To send an information template pertaining to article 29 to recipient 17 using system 1, information template sender 19 clicks on link 31 that directs information template sender 19 to an information template sender registration screen 33 shown in FIG. 5. It will be obvious to one of ordinary skill to have information template sender registration screen 33 hosted on any Internet-connected server including, but not limited to, the server that hosts the web site containing article 29 or the server that hosts system 1.

Information template sender registration screen 33 includes a login screen 35, a sender information screen 37, a recipient information screen 39 and a delivery criteria screen 41.

Login screen 35 includes an ID box 35a and a password box 35b into which information template sender 19 enters an identification code and password, respectively, for identifying information template sender 19 to system 1. By logging onto system 1, information template sender 19 gains access to premium services provided by system 1 to assist information template sender 19 in sending an information template to particular subscribers. Alternatively, information template sender 19 does not log into system 1 by providing an ID and password in which case information template sender 19 does not gain access to the premium services but otherwise can send an information template to recipients 17.

Sender information screen 37 includes a sender name box 37a and a sender email address box 37b in which information template sender 19 enters his/hers name and email address, respectively, that is used to identify information template sender 19 to the recipients of article 29.

Recipient information screen 39 includes a recipient name box 39a and a recipient email address box 39b into which information template sender 19 enters the names and email addresses of those of recipients 17 that information template sender 19 wishes to send article 29. In an exemplary embodiment, if information template sender 19 logs onto system 1, in a manner described above, information template sender 19 gains access to premium services, such as by way of non-limiting example, an address book that can be used to store names and email addresses of subscribers and retrieve such names and email addresses for inclusion in recipient information screen 39.

Delivery criteria screen 41 includes a relevancy box 41a in which information template sender 19 selects a relevancy measure indicating, in the view of information template sender 19, the relevancy of article 29 to the interests of recipients. Delivery criteria screen also includes a time criticality box 41b in which information template sender 19 selects a time criticality measure indicating, in the view of information template sender 19, how critical it is that the selected recipients receive article 29. In an exemplary embodiment, information template sender 19 also chooses from a response priority box 41d a priority that will be assigned to recipients' 17 response. Thus, the information template sender 19 can dictate ahead of time whose responses are more important. Finally, delivery criteria screen 41 includes a text box 41c in which information template sender 19 may include a note that will be presented by system 1 to recipients along with the information template related to article 29. In the event information template sender 19 desires to send article 29 to more than one of recipients 17, information template sender 19 can choose to have delivery criteria screen 41 replicated for each of those recipients 17.

After information template sender 19 enters the required information in information template sender registration screen 33, information template sender 19 initiates the sending of the selected information template by activating a send button 43 on information template sender registration screen.

The information templates that are registered for by recipients 17 and that are sent by information template senders 19, together with any priority preferences and delivery criteria, are received by a content provider interface 5 included in system 1. Generally, content provider interface 5 ensures the integrity of the information templates received by system 1 and also enables content providers 15 to manage and control delivery of information templates to recipients 17.

Content provider interface 5 determines whether any particular information template received from one of content providers 15 has already been received, and is presently stored, by system 1. The receipt of duplicate templates by system 1 may occur if, for example, several information template senders 19 send the same information template to any of recipients 17 of system 1. Although it is not possible for recipient 17 to subscribe to a subscription twice (system 1 prevents this), it is possible for recipient 17 to subscribe to multiple subscriptions from the same content provider 15. In this case, if content provider 15 publishes the same information template to multiple subscriptions, recipient 17 will only receive one copy of the information template.

To determine whether a particular template received by content provider interface 5 is currently stored on system 1, content provider interface 5 queries a template database 3 that stores all the information templates received by system 1, and not otherwise deleted, as to whether the particular information template in stored in template database 3. If the information template is not stored in template database 3, then content provider interface 5 forwards the information template to template database 3 for storage therein. Content provider interface 5 also forwards any priority information or delivery criteria associated with the particular information template to a priority manager 9 for organizing the information template according to such priority information and delivery criteria. On the other hand, if the information template is already stored in template database 3, then the duplicate information template will not be stored again in template database 3 thereby reducing the storage demands on system 1. In this case too, however, content provider interface 5 forwards the priority information and delivery criteria associated with the duplicate information template to priority manager 9 so that the organization of the information template may be updated according to such priority information and delivery criteria.

Content provider interface 5 also enables content providers 15 to manage the information templates that were sent to system 1. For example, in the event that content provider 15 desires to take back a particular information template, then content provider 15 issues a request to system 1 through content provider interface 5 to have the particular template removed from system 1. Content provider interface 5 then determines which recipients 17 have not viewed the particular information template yet and instructs priority manager 9 to delete the references to the particular information template. In an exemplary embodiment, content provider 15 can substitute a new information template for the information template that is being taken back. In yet another exemplary embodiment, content provider 15 can request content provider interface 5 to send a retraction template to all recipients 17 that still have a reference to a particular information template, whether it was received via a subscription or from information template sender 19. The retraction template is an information template that explains to the recipients 17 what was incorrect with the original information template.

In an exemplary embodiment, when content provider 15 updates a particular information template stored in template database 3, recipients 17 will still have reference to the original information template that they received. However, when recipient 17 attempts to forward the information template to another person, system 1 will display the latest edition of the information template and inform recipient 17 that the information template was updated. Content provider 15 has the ability to configure an information template to allow recipients 17 to forward the original information template that they received or to allow recipients 17 to forward the latest edition only.

Content provider interface 5 allows content provider 15 to change the control options on information template stored in template database 3 even after the information template were already received by recipients 17. Content provider 15 can change the URL of the information template, so that when recipients 17 click to view the full messages, their browser is redirected to the new URL. Content provider 15 can also change the maximum number of recipients that an information template can be sent to by recipients 17. Content provider 15 can specify that an information template can no longer be forwarded to any more people or can no longer be read by anyone. Content provider 15 can change which subscriptions are displayed to recipient 17 when reading or sending the information template. Thus, system 1 enables content providers 15 to control and manage the information they provide even after such information is transmitted to system 1.

Content provider interface 5 also enables one of content providers 15 to distribute the same or similar information in different formats to evaluate which of the formats are most liked by recipients 17. To accomplish this, the one of content providers 15 will incorporate the information to be distributed into multiple information templates each having a different design and/or format, as desired. Each time a request is made of the one of content providers 15 for forwarding such information to one of recipients 17, content provider interface 5 randomly selects one of the multiple information templates for storage in template database 3. Because each of recipients 17 may receive the subscribed to information via a differently designed information template, the one of content providers 15 can track the recipients' 17 responses to the differently designed information templates and determine the advantages/disadvantages of each.

In communication with content provider interface 5 is address book 7 that, as described above, allows information template sender 19 to store names and email addresses of recipients 17 and retrieve such names and email addresses for inclusion in recipient information screen 39. In addition, the email addresses of all recipients 17 to which information template sender 19 sends an information template to is automatically added to address book 7.

Content provider interface 5 also monitors address book 7 to track the activity of information template sender 19 and detect undesirable activity such as spam. For example, if information template sender 19 repeatedly sends the same information templates to hundreds of recipients 17 simultaneously, content provider interface 5 detects such activity through the use of address book 7 by information template sender 19. If such activity is judged to be undesirable, then content provider interface 5 may take a number of actions to prevent such activity including, but not limited to, limiting the number of recipients 17 that information template sender 19 may send an information template to or preventing information template sender 19 from sending information templates to any recipients 17.

As described above, the subscription priority information and the delivery criteria associated with a particular information template is forwarded by content provider interface 5 to priority manager 9. Priority manager 9 organizes all information templates destined for a particular recipients 17 according to such subscription priority information and delivery criteria. In particular, priority manager 9 retrieves the information templates destined for each of recipients 17 from template database 3 and sequences the information templates in an order based on the subscription priority information, delivery criteria, and other priorities set by recipients 17.

As described above, recipients 17 assign subscription priority numbers when subscribing to received information templates published by content providers 15 and information template senders 19 provide delivery criteria when requesting that an information template be sent to recipients 17. The subscription priority and delivery criteria are evaluated by priority manager based on other priority information provided by recipients 17 including general priority information, sent priority and sender priority.

Referring now to FIG. 7, there is shown an input screen 71 into which recipients 17 enter general priority information. For each category of information templates that recipients 17 may receive, recipients 17 assign a point value that is used by priority manager 9 to calculate the overall priority of any particular information template. For example, if numerous information template senders send an information template to recipient 17, then the recipient 17 may increase the priority point value of the information template accordingly. Similarly, priority point values may be assigned by recipient 17 to the other information template (message) types shown in FIG. 7 and described in Table 1 below. In addition, other information template categories, criteria, and rules may be identified in which the recipient 17 can assign a priority point value.

TABLE 1

| Information Template Category | Explanation |
|---|---|
| First time information template | The first time the recipient receives an |
| | information template, nothing known |
| | about it yet. |
| Sent | This is the initial value that is given to |
| | all sent information templates. Usually |
| | sent information templates are more |
| | important than subscribed information |
| | templates and this can push up all sent |
| | information templates if the recipient's |
| | subscriptions are currently getting more |
| | priority points. |
| Points for each extra person | The more people that thought a given |
| it was sent by | information templates is relevant |
| | indicates that it probably is important |
| Receiving an information | By reading the information template, |
| template again after | the recipient indicates that the |
| reading it | information template was important |
| | enough to read |
| With a note | If there's a note attached, then even |
| | though the recipient read the |
| | information template already, the |
| | information template sender may have |
| | written something important in the |
| | note. |
| Without a note | If there is no note, then there's nothing |
| | new here for the recipient to read. |
| Receiving an information | By saving the information template, the |
| template again after | recipient indicates that the information |
| I already saved it | template was important. |
| With a note | If there's a note attached, then even |
| | though the recipient read the |
| | information template already, the |
| | information template sender may have |
| | written something important in the |
| | note. |
| Without a note | If there is no note, then there's nothing |
| | new here for the recipient to read. |
| Receiving an information | By deleting the information template, |
| template again after | the recipient is indicating that the |
| I already deleted it | information template was not really |
| | important. |
| With a note | Although the information template may |
| | not be important, the note may be |
| | important enough to read. |
| Without a note | If there is no note, then there's nothing |
| | new here for the recipient to read. |
| Points for each time I | Each time the recipient deletes the same |
| deleted this information | information template, it indicates even |
| template already | more how unimportant the information |
| | template is to the recipient. |

Referring now to FIG. 8, there is shown an input screen 81 into which recipients 17 enter sent priority information. As describe earlier, information template senders 19 select a relevancy measure in relevancy box 41a and a time criticality measure in time criticality box 41b that is appropriate considering the information template contents and the particular recipient(s). For example, if the information template relates to a sales coupon that is to expire in 1 day, then a sender may select a more time critical measure. In order for priority manager 9 to evaluate the relevancy and time criticality measures assigned by a sender, recipients 17 assign priority point values to each of the relevancy and time criticality measures that may be selected by the sender. So, for example, for a “Definitely yes” measure 82, recipient 17 may assign a sixty-five point relevancy measure 83 and a thirty-five point time criticality measure 84. In addition, recipient 17 may assign a ten-point late point factor 85 in which case the time criticality measure is automatically increased by the late point factor for each day the particular information template is not read. In this way, recipient 17 can have the priority for older unread information templates increased. Similarly, recipient 17 assigns point values for all other measures that the sender may select. Thus, when information template senders 19 select a particular relevancy or time criticality measure, the selected measure is evaluated based on the priority point factor assigned by the particular recipient 17. In an exemplary embodiment, this is simplified for recipient 17 by allowing recipient 17 to specify priority in a descriptive manner (e.g., “Very high”, “High”, “Low”, “Very Low”, etc.) instead of having to select a specific number.

In yet another exemplary embodiment, the information template senders 19 can choose a response priority, which is used to prioritize the responses that are sent back by the recipients 17 for this information template. For example, if information template sender 19 sends a joke to his friends, he is not interested in their responses, so he'll choose “Very low” for his response priority. However, if information template sender 19 sends a information template about a relevant product to his business associates, he will be interested in their responses, so he'll choose “Very high” for his response priority.

Referring now to FIG. 9, there is shown an input screen 91 into which recipients 17 enter sender priority information. Recipients 17 may assign a priority point value for each sender 19 that recipients 17 receive information templates from. For example, if recipient 17 repeatedly receives valuable information from a particular sender, then recipient 17 may increase the priority point value associated with that sender. Alternately, recipient 17 can decrease the priority point value associated with any sender that sends recipient 17 useless information. In an exemplary embodiment, address book 7 stores contact information for entities that send information templates to, and receive information templates from recipients 17. In this embodiment, recipients 17 may assign a priority point value to each entity stores in address book 7. Thus, recipients 17 can adjust the overall priority a particular information template receives based on the sender of the information template.

In addition to the subscription priority information, delivery criteria, general priority information, sent priority and sender priority, recipients 17 may set priority values in any number of ways including, by way of non-limiting example, based on key words and subject matter. Also, overall priority for a given information template may be based on monitoring the actions of a particular recipient 17. For example, if recipient 17 views a particular information template first, ahead of all the other information templates that are displayed alongside it, then the priority value of the subscription that the information template was published through is made higher than the priority values of information templates associated with the remaining subscriptions.

Priority manager 9 receives the general priority information, sent priority and sender priority provided by recipient 17 via access server 13. When an information template is received by system 1 on behalf of a particular recipient 17, priority manager 9 uses the subscription priority information and/or delivery criteria associated with the information template and, based on the general priority information, sent priority and sender priority provided by the particular subscriber, assigns a overall priority point value for the particular information template. Based on the overall priority point value for each information template for each of recipients 17, priority manager 9 forms a sequence of information templates for each of recipients 17.

Priority manager 9 then stores the information template sequence for the templates destined for each of recipients 17 in a page layout database 11. When one of recipients 17 desires to view the subscribed to information templates or the information templates sent by information template sender 19, the one of recipients 17 communicates with access server 13, using techniques well known in the art, and requests that one of recipients 17 information templates. By way of non-limiting example, access server 13 may be a web server in which case recipients 17 communicate with access server 13 by operating browser software. Upon receiving the request from the one of recipients 17, access server 13 communicates with page layout database 11 and retrieves the sequenced information templates stored therein for that one of recipients 17. Access server 13 then forwards the sequence of information templates to the one of recipients 17 for viewing.

Referring now to FIG. 6, there is shown a screenshot 61 of a sequence of information templates as viewed by a particular recipient 17. Screenshot 61 is partitioned into four segments: a New Knowledge segment 62, a Current Knowledge segment 63, and Ongoing Knowledge segment 64 and a Save Knowledge segment 65.

New Knowledge segment 62 includes a sequence of newly received information templates that have not yet been viewed by the recipient 17. In screenshot 61, New Knowledge segment 62 contains three information templates 62(1)-62(3) that have been sequenced by priority manager 9 according to the appropriate priority information and delivery criteria. For example, information template 62(1) in New Knowledge segment 62 is a brief description of a book being offered for sale by amazon.com®. The brief description also includes a hyperlink that when activated leads recipient 17 to a full description of the book that resides on the particular content provider's site, in this example amazon.com®.

Also included in information template 62(1) is a series of action hyperlinks 62(1)a-e via which recipient 17 may take action with respect to information template 62(1). For example, by activating a save hyperlink 62(1)a, information template 62(1) is saved. In and exemplary embodiment, upon activating save hyperlink 62(1)a, recipient 17 is provided with the option of saving information template 62(1) to a particular selectable folder so that all saved information templates can be organized. In addition, recipient 17 may include a descriptive comment to be stored together with saved information template 62(1). Similarly, by activating action hyperlinks 62(1)b-e, recipient 17 can forward, respond to, prioritize and remove information template 62(1), respectively.

When a recipient 17 activates any action hyperlink, the desired action request is captured by access server 13 and forwarded to a recipient action manager 14 that causes the desired action request to be fulfilled. For example, if recipient 17 activates save hyperlink 62(1)a, recipient action manager 14 receives this action request and notifies priority manager 9 of recipient's 17 intent to save information template 62(1). Similarly, if recipient 17 activates forward hyperlink 62(1)b indicating a desire to forward information template 62(1) to a certain recipient, then recipient action manager 14 causes information template to be sent to the specified recipient via a communications link 16.

When recipient 17 activates the prioritize action hyperlink, then recipient 17 is presented with a list of all senders who sent recipient 17 the information template as well as the subscriptions that was used to publish the information template to recipient 17. The senders and subscriptions are listed with the current number of points that recipient 17 last assigned to them. Recipient 17 can change the number of points which will be used to prioritize all future information templates.

When recipient 17 activates the remove action hyperlink, the information template is removed from New Knowledge and disappears from system 1. Internally, system 1 still keeps additional information such as the number of times this information template was removed in order to prioritize the information template if another information template sender sends the same information template again. (Each time recipient 17 removes an information template, the priority is decreased for future deliveries of the same information template.)

Adjacent information template 62(1) is a delivery information section 62(4) that indicates the source of information template 62(1) and what actions recipient 17 may take. In this example, delivery information section 62(4) indicates that information template 62(1) was sent by an information template sender named Kay Justin who added a information template “Just finished it. You will love it.” As described above, an information template sender adds an information template by inserting the text box 41c when the information template sender initially sends the information template to recipient 17. Delivery information section 62(4) also includes actions recipient 17 may take regarding information template 62(1). For example, by activating a respond hyperlink 62(4)a, recipient 17 may communicate a response to the information template sender.

New Knowledge segment 62 also includes information template 62(2) that includes a promotional information template from an electronic retailer that was subscribed to by the particular recipient 17. Information template 62(2) also includes a series of action hyperlinks 62(2)a-d via which recipient 17 may take action with respect to information template 62(2). In particular, by activating Unsubscribe hyperlink 62(2)c, recipient 17 will no longer receive information templates from the particular content provider.

New Knowledge segment 62 also contains information template 62(3) that includes promotional material sent to recipient 17 by a information template sender named George Macro. Information template 62(3) also includes a series of action hyperlinks 62(3)a-c. In particular, by activating Subscribe hyperlink 62(3)b, recipient 17 is presented with one or more subscriptions that content provider 15 defined in this information template. Recipient 17 is encouraged to subscribe to receive information templates directly from the particular content provider instead of relying on information template sender 19 for receiving such information templates. The headline and summary is displayed for the most important information templates, and only the headline is displayed for the rest. Recipient 17 reads an information template by clicking on the hyperlink in the information template and recipient 17 is transported to content provider's 15 site to the URL that content provider 15 defined in this information template.

Current Knowledge segment 63 of screenshot 61 includes information templates 63(1) that were read by recipient 17. The headlines of the information templates 63(1) included in Current Knowledge segment 63 are defined in the information templates. If recipient 17 desires to view the summary of the information template 63(1), recipient 17 activates a “See full description” hyperlink 63(2) that causes the corresponding complete information template to be displayed to recipient 17. Information templates 63(1) contained in Current Knowledge segment 63 also have associated therewith a series of action hyperlinks 63(3) that allow recipient 17 to, for example, save, forward, subscribe, respond to, or remove a particular one of information templates 63(1) contained in Current Knowledge segment 63. Finally, each of information templates 63(1) contained in Current Knowledge segment 63 have associated therewith an expiration date 63(4) at which time the particular one of information templates 63(1) is removed from Current Knowledge segment 63. As far as recipient 17 is concerned, the information template is removed from system 1. However, internally, system 1 still keeps additional information such as the total number of times that recipient 17 sent the information template in case content provider imposes a limit on the number of people it can be sent to. If recipient 17 activates the save hyperlink associated with a particular information template contained in Current Knowledge segment 63, then that particular information template will be included in Saved Knowledge segment 65. In either case, subscriber action manager 14 monitors whether any of information templates 63(1) is to be removed from Current Knowledge segment 63 or save to Saved Knowledge segment 65 and causes priority manager 9 to update template database 3 and page layout database 11 accordingly.

Ongoing Knowledge segment 64 of screenshot 61 includes information templates 64(1) displayed only with headlines regarding which recipient 17 has previously engaged in communications by, for example, either responding to or forwarding to another. Each of information templates 64(1) contained in Ongoing Knowledge segment 64 has associated therewith a plurality of action hyperlinks 64(2) that enable recipient 17 to manage recipient's 17 communications regarding information templates 64(1). Action hyperlinks 64(2) enable recipient 17 to, by way of non-limiting example, view the history of recipient's 17 communications regarding any of information templates 64(1) and engage in further communications regarding any of information templates 64(1).

Finally, Saved Knowledge segment 65 of screenshot 61 includes information templates 65(1) displayed only with headlines that recipient 17 has previously saved. If recipient 17 desires to also view the summaries of the information templates 65(1), recipient 17 activates a “See full descriptions” hyperlink 65(2) that causes the corresponding complete information template to be displayed to recipient 17. Saved Knowledge segment 65 also includes a folder section 65(3) that displays which folder each particular information template was saved in and a Comments section 65(4) that displays the comment that recipient 17 had entered to help in remembering the reason the information template was saved in the first place.

In an exemplary embodiment, recipient 17 must periodically resave each of information templates 65(1) to remain stored Saved Knowledge segment 65 or else the particular information template will be removed from Saved Knowledge segment 65. Requiring recipient 17 to resave each of information templates 65(1) provides an indication regarding recipient's 17 interest level with respect to each of information templates 65(1). For example, if recipient 17 repeatedly resaves an information template pertaining to a product description from a particular content provider, then it is likely that recipient 17 is contemplating a purchase of such a product. Subscriber action manager 14 monitors the repeated resaving of an information template and this information, which may indicate an interest level in the particular product, is provided to the particular content provider via content provider interface 5. In an exemplary embodiment, subscriber action manager 14 monitors the interest level in a particular product displayed by all subscribers and forwards this information to the content provider. Additionally, the content provider may be charged a fee that is proportional to the length of time the particular information template provided by the content provider is saved in Save Knowledge segment 65.

Because the number of information templates to be displayed on screenshot 61 may exceed the viewable area of the display device being operated by recipient 17, each segment within screenshot 61 allows recipient 17 to view all the information templates contained, but not initially displayed, in a particular segment. For example, New Knowledge segment 62 shown in screenshot 61 displays three out of the five information templates contained in New Knowledge segment 62. To view the remaining two information templates, recipient 17 activates a Next hyperlink 62(5) that causes the remaining two information templates to be displayed in New Knowledge segment 62. In another embodiment, each segment in screenshot 61 is a scrollable window, designed using well-known techniques, in which recipient 17 may scroll through to view information templates not initially displayed.

In an exemplary embodiment, content provider 15 can specify distribution policies for information templates. Distribution policies include no pornography, minimum suitable age, suitable locale, and anything else content provider 15 may consider necessary to limit distribution of the information template for legal, social, or financial purposes. Recipient 17 is only allowed to view the information template if the distribution policies are suitable for recipient 17 based on the information in recipient's 17 personal profile. If recipient 17 never entered the appropriate information into recipient's 17 personal profile, then recipient 17 is informed that the information templates will be withheld until the requisite information is entered. If recipient 17 entered the appropriate information into recipient's 17 personal profile, but based on the distribution policies, the information template is not suitable for recipient 17, then the information template is not shown to recipient 17 and information template sender 19 is notified that the recipient 17 was unable to accept delivery of the sent information template. For example, if a friend sent recipient 17 a pornographic information template, then recipient 17 would not be permitted to see the pornographic information template until recipient 17 specifies in his personal profile whether or not recipient 17 wishes to view pornographic information templates. If recipient 17 decides not to view pornographic information, all pornographic information templates are automatically rejected from recipient's 17 account without recipient 17 ever seeing the offensive material, and the information template is return to the sender with an appropriate error message.

In another exemplary embodiment, content provider 15 can define multiple languages in an information template. Every recipient 17 has a preferred language as part of recipient's 17 personal profile and the information template is displayed to recipient 17 in his preferred language (if available). If the preferred language is not available, then it is displayed in the default language, also defined by content provider 15. For example, if a content provider created an information template and defined it in French and English and set the default language to English, then a recipient 17 whose preferred language is French will have the information template displayed in French. A recipient 17 whose preferred language is English will have the information template displayed in English. A recipient 17 whose preferred language is German will have the information template displayed in English (the default language) because German was not defined by content provider 15. A recipient 17 can specify alternate languages in recipient's 17 personal profile, and the information template will be displayed in the alternate language when the preferred language is not available.

Using system 1 of the present invention, content providers can effectively control the distribution of their content through system 1. For example, assume a retailing content provider provides a coupon discount for a particular product it sells and would like to control the number of coupons distributed. To accomplish this, the content provider creates an information template that includes the discount coupon and would incorporate in the information template the maximum number of discount coupons that can be distributed through system 1. When either a subscriber subscribes to the information template or a information template sender sends the information template to a recipient through system 1, content provider interface 5 forwards to priority manager 9 the maximum number copies that may be sent to subscribers or sent by subscribers to others. Based on the priority information and delivery criteria contained in priority manager 9, as well subscriber actions monitored by subscriber action manager 14, priority manager 9 determines whether the maximum number of copies have been reached and, if so, takes the action designated by the content provider. For example, the content provider may instruct priority manager 9 to lower the coupon discount by some amount after a certain number of coupons have been distributed.

Thus, content providers may impose any limitations and controls on the content provided to system 1 thereby enabling the content provider to track and control the distribution of their content.

Accordingly, a system and method is provided for distributing to a plurality of recipients a broad range of information gathered from a plurality of content providers based on the preferences of each particular recipient and the relevancy and timeliness of the information.

Based on the above description, it will be obvious to one of ordinary skill to implement the system and methods of the present invention in one or more computer programs that are executable on a programmable system including at least one programmable executable or coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable executables include, by way of example, both general and special purpose microexecutables. Furthermore, alternate embodiments of the invention that implement the system in hardware, firmware or a combination of both hardware and software, as well as distributing modules and/or data in a different fashion will be apparent to those skilled in the art and are also within the scope of the invention.

It will thus be seen that the objects set forth above, among those made apparent from the preceding description, are efficiently attained and, since certain changes may be made in carrying out the above process, in a described product, and in the construction set forth without departing from the spirit and scope of the invention, it is intended that all matter contained in the above description shown in the accompanying drawing shall be interpreted as illustrative and not in a limiting sense.

It is also to be understood that the following claims are intended to cover all of the generic and specific features of the invention herein described, and all statements of the scope of the invention, which, as a matter of language, might be said to fall therebetween.

1. A system for delivering information from a plurality of content providers to a plurality of recipients, comprising:
a plurality of information templates, each of said plurality of information templates including information provided from one of said plurality of content providers;
a priority manager for managing priority information of each of said plurality of recipients;
a template database for storing said plurality of information templates;
wherein at least one of said plurality of recipients is presented with at least one of said information templates according to said priority information of said at least one of said plurality of recipients.

2. The system of claim 1, wherein said at least one of said plurality of recipients subscribe to said at least one of said plurality of content providers for receiving said at least one of said information templates and for indicating subscription preferences to be associated with said at least one of information template.

3. The system of claim 2, wherein said subscription preferences include priority preferences.

4. The system of claim 2, wherein said subscription preferences includes privacy preferences.

5. The system of claim 2, further comprising at least one information template sender, said at least one information template sender causing at least one of said plurality of information templates from one of said plurality of content providers to be presented to at least one of said plurality of recipients according to deliver criteria.

6. The system of claim 5, wherein said delivery criteria includes a relevancy and time critical measure of said information template.

7. The system of claim 5, wherein said delivery criteria includes a response priority measure of said information template.

8. The system of claim 5, wherein said delivery criteria is received by said priority manager and is evaluated in light of said preferences of said at least one of said plurality of recipients.

9. The system of claim 5, wherein said information template sender adds additional information to said at least one of said plurality of templates and wherein said additional information is presented to said at least one of said plurality of recipients.

10. The system of claim 5, wherein said information template sender adds a note to one of said plurality of information templates.

11. The system of claim 5, further comprising a content provider interface, said content provider interface receiving said plurality of information templates from said content providers and forwarding said information templates to said template database.

12. The system of claim 11, wherein said content provider interface receives said subscription priority information and said delivery criteria from said content providers and forwards said subscription priority information and said delivery criteria to said priority manager.

13. The system of claim 1, further comprising a distribution policy and wherein at least one of said plurality of recipients is presented with at least one of said information templates according to said distribution policy.

14. The system of claim 13, wherein if one of said plurality of information templates does not meet said distribution policy, said one of said information templates is not presented to said at least one of said plurality of recipients.

15. The system of claim 1, further comprising a language preference and wherein at least one of said plurality of recipients is presented with at least one of said information templates according to said language preference.

16. The system of claim 11, wherein said content provider interface receives a request from one of said content providers to take back one of said plurality of information templates and said content provider interface deletes a reference to said one of said plurality of information templates from those of said plurality of recipients that did not view said one of said plurality of information templates.

17. The system of claim 11, wherein said content provider interface causes one of said plurality of information templates to be updated with a new information template by one of said content providers.

18. The system of claim 17, wherein when one of said plurality of recipients forwards said one of said plurality of information templates, said one of said plurality of recipients is notified that said one of said plurality of information templates was updated with said new information template.

19. The system of claim 11, wherein said content provider interface receives from at least one of said plurality of content provider multiple information templates and said content provider interface randomly selects one of said multiple information templates for storing in said template database.

20. The system of claim 11, further comprising an address book accessible by said at least one information template sender for storing and retrieving contact information of said plurality of recipients.

21. The system of claim 20, wherein said content provider interface monitors said address book for detecting undesirable activity.

22. The system of claim 21, wherein if said content provider interface detects undesirable activity, said content provider interface limits said at least one information template sender's access to said address book.

23. The system of claim 5, wherein said priority information includes general priority information provided by said at least one of said plurality of recipients.

24. The system of claim 23, wherein said priority information includes sent priority information provided by said at least one of said plurality of recipients.

25. The system of claim 24, wherein said priority information includes sender priority information provided by said at least one of said plurality of recipients.

26. The system of claim 1, wherein said priority manager forms a sequence of information templates from some of said plurality of information templates based on said priority information and wherein said sequence of information templates is presented to at least one of said recipients.

27. The system of claim 5, wherein said priority manager forms a sequence of information templates from some of said plurality of information templates based on said priority information and said delivery criteria and wherein said sequence of information templates is presented to at least one of said recipients.

28. The system of claim 25, wherein said priority manager forms a sequence of information templates from some of said plurality of information templates based on said subscriber priority information, said delivery criteria, said general priority information, said sent priority information and said sender priority information and wherein said sequence of information templates is presented to at least one of said recipients.

29. The system of claim 28, further comprising a page layout database wherein said sequence of information templates is stored in said page layout database.

30. The system of claim 28, wherein said sequence of information templates includes information templates not previously viewed by said at least one of said recipients.

31. The system of claim 30, wherein when any of said sequence of information templates are viewed by said at least one of said recipients, said any of said sequence of information templates are displayed to said at least one of said recipients in a second sequence of information templates.

32. The system of claim 31, wherein said information templates in said second sequence of information templates are displayed for a predetermined period of time.

33. The system of claim 31, wherein when any of said information templates in said sequence of information templates and said second sequence of information templates is saved by said at least one of said recipients, said saved information templates are displayed in a third sequence of information templates.

34. The system of claim 33, wherein said information templates in said third sequence of information templates are deleted from said third sequence of information templates unless said information templates in said third sequence of information templates are resaved by said at least one of said recipients.

35. The system of claim 34, wherein said one of said plurality of content providers providing any of said information templates in said third sequence of information templates is charged a fee based on a period of time said any of said information templates is in said third sequence of information templates.

36. A method for delivering information from a plurality of content providers to a plurality of recipients, comprising the steps of:
receiving a plurality of information templates from said plurality of content providers wherein each of said plurality of information templates includes information provided from one of said plurality of content providers;
managing priority information of each of said plurality of recipients;
storing said plurality of information templates;
receiving from at least one of said plurality of recipients priority information; and
presenting at least one of said information templates to said at least one of said plurality of recipients according to said priority information of said at least one of said plurality of recipients.

37. The method of claim 36, further comprising the steps of:
receiving from a information template sender at least one of said plurality of information templates and delivery criteria; and
presenting to at least one of said plurality of recipients said at least one of said plurality of information templates according to said deliver criteria.

38. The method of claim 37, wherein said priority information includes general priority information.

39. The method of claim 38, wherein said priority information includes sent priority information.

40. The method of claim 39, wherein said priority information includes sender priority information.

41. The method of claim 40, further comprising the steps of:
forming a sequence of information templates from some of said plurality of information templates based on said subscriber priority information, said delivery criteria, said general priority information, said sent priority information and said sender priority information; and
presenting said sequence of information templates to at least one of said recipients.

42. The method of claim 36, further comprising the step of:
receiving from at least one of said plurality of recipients subscription preferences.

43. The method of claim 36, further comprising a distribution policy and further comprising the step of:
presenting at least one of said information templates to said at least one of said plurality of recipients according to said distribution policy.

44. The method 43, wherein if one of said plurality of information templates does not meet said distribution policy, said one of said information templates is not presented to said at least one of said plurality of recipients.

45. The method of claim 36, further comprising a language preference and further comprising the step of:
presenting at least one of said information templates to said at least one of said plurality of recipients according to said language preference.

46. The method of claim 36, further comprising the step of:
updating one of said plurality of information templates with a new information template provided by one of said content providers.

47. The system of claim 46, further comprising the steps of:
receiving a request from one of said plurality of recipients to forward said one of said plurality of information templates, and
notifying said one of said plurality of recipients that said one of said plurality of information templates was updated with said new information template.
